(19) United States
(12) Patent Application Publication
(10) Pub. No.: US 2005/0185624 A1
(43) Pub. Date: Aug. 25, 2005

(54) Communication system and method for processing a request message sent from a mobile radio terminal of a mobile radio communication network to a message filter processor

(75) Inventors: Frank-Uwe Andersen, Berlin (DE); Michael Finkenzeller, Munchen (DE); Jochen Grimminger, Munchen (DE)

Correspondence Address: MORRISON & FOERSTER LLP, 1650 TYSONS BOULEVARD, SUITE 300, MCLEAN, VA, 22102, US

(73) Assignee: Siemens Aktiengesellschaft, Munchen (DE)

(21) Appl. No.: 11/038,464

(22) Filed: Jan. 21, 2005

(30) Foreign Application Priority Data
Jan. 23, 2004 (DE) 10 2004 003 549.0

(51) Int. Cl. H04Q 7/24

(52) U.S. Cl. 370/338; 455/412.1

(57) ABSTRACT

A method is described for processing a request message sent from a mobile radio terminal to a message filter processor, in which a request message, in which one or more electronic peer-to-peer files is/are requested, is detected by the message filter processor (102,103,104. The request message is used to create a peer-to-peer request message according to a predefined peer-to-peer communication protocol. The peer-to-peer request message is sent to at least one processor (201 . . . 207) in a fixed network communication network (200), the request message being present in the form of a data packet (300), having a packet header (301) and user data (302), and detection of the request message including reading data in the packet header (301) of the request message, the data being used to identify a specific peer-to-peer application.

### CLAIM FOR PRIORITY

This application claims the benefit of priority to German Application No. 10 2004 003 549.0 which was filed in the German language on Jan. 23, 2004, the contents of which are hereby incorporated by reference.

The invention relates to a method for processing a request message sent from a mobile radio terminal of a mobile radio communication network to a message filter processor and a computer program product.

It is known that peer-to-peer services can be supplied by processors linked together by means of a fixed network communication network. So-called superpeer processors are used in the fixed network communication network, which are superior in performance, i.e. in computing capacity and data storage in respect of the quantity of data that can be stored, to “standard” peer-to-peer processors. The architecture, in which the superpeer processors are used in the context of peer-to-peer services is also referred to as hybrid peer-to-peer processor architecture.

Communication in the fixed network communication network generally takes place according to the Internet Protocol (IP) and the Transport Control Protocol (TCP)/User Datagram Protocol (UDP) and according to the peer-to-peer protocol assigned to the peer-to-peer service used in each instance.

If a peer-to-peer service is to be used by the mobile radio terminal in the context of a packet-switched communication with a mobile radio terminal, the performance of a peer-to-peer service used by said terminal essentially depends on where in the fixed network communication network a superpeer processor associated with the respective service is located. With peer-to-peer service data traffic generated by a mobile radio terminal, in the case of GPRS (General Packet Radio Service) for example the data packets of the data traffic always have to be routed via the GGSN processor (Gateway GPRS Support Node processor) into the Internet-based fixed network communication network and in the most unfavorable instance back into a mobile radio communication network.

Significant resources are required for this procedure, both with regard to the computing power of the processors involved and also the available bandwidth of both the fixed network communication network and the mobile radio communication network, which can in some instances have an adverse effect on other data traffic or other voice traffic within the mobile radio communication network.

Current mobile radio terminals are however not suitable for direct use in peer-to-peer networks for a number of reasons.

Mobile radio communication connections in mobile radio communication networks set up according to the GSM standard or another third generation mobile radio standard, e.g. GPRS, currently have low bit rates.

Also the storage space available in current mobile radio terminals is very restricted and it is not foreseeable, even in the future, that mobile radio terminals will be able to provide a storage capacity of several gigabytes, as is for example available with current standard personal computers.

It is also very likely that the use of a mobile radio terminal in a peer-to-peer network would incur uneconomically high costs for the user of the mobile radio terminal, as the search algorithms to detect the required electronic peer-to-peer files would take up almost all the capacity of a standard mobile radio terminal.

The requested content can also not be used or executed on the mobile radio terminal itself, particularly due to user interface limitations, such as the absence of a screen for video, inadequate graphics capability, absence of or inadequate speakers, etc.

In the mobile radio communication network IP data packets are combined in a user-specific manner in so-called GTP (GPRS Tunneling Protocol) tunnels and PDP contexts. Within these contexts all packets are handled in the same manner and forwarded together to the GGSN network element. From hereon, purely IP-typical forwarding rules are applied. The operator of a mobile radio communication network generally does not process packets for specific (peer-to-peer) services in a specific manner.

Attempts are made to block peer-to-peer file sharing by so-called packet filters, which search user data within an IP packet for specific bit patterns. A specific service is generally identified and blocked using the IP port. Software at router level is also known, with which the data traffic of a network can be monitored. The system provided by Audible Magic searches for bits, which are transported by FTP or Gnutella protocol. A technology known as fingerprint technology is thereby used to identify files uniquely and to recognize copyright-protected music. Although to date the system has had purely monitoring functions, it is claimed that in future it will also be able to block the exchange of protected files.

The object of the invention is to specify a method and a communication system allowing mobile radio terminals to be used in a peer-to-peer network in a low-cost and economically viable manner.

This object is achieved by the method with the features of claim 1, a computer program product with the features of claim 14 and a communication system with the features of claim 15. Advantageous embodiments will emerge from the dependent claims.

With the method according to the invention for processing a request message sent from a mobile radio terminal of a mobile radio communication network to a message filter processor, a request message, in which one or more electronic peer-to-peer files is/are requested, is detected by the message filter processor. The request message is used to create a peer-to-peer request message according to a predefined peer-to-peer communication protocol. The peer-to-peer request message is sent to at least one processor in a fixed network communication network. The request message is thereby present in the form of a data packet, having a packet header and user data, detection of the request message including reading data in the packet header of the request message, the data being used to identify a specific peer-to-peer application. This means that a network element is able to use information in an IP header, which is not source and destination addresses, to make a forwarding decision, the packet header containing additional information, which allows this forwarding decision to be made.

Generally a generic request message containing details about the destination for the requested files is converted to a protocol-specific request message. The message filter processor is set up to detect request messages sent from a mobile radio communication network in the message filter processor, which request one or more electronic peer-to-peer files, and to use them to create peer-to-peer request messages according to a predefined peer-to-peer communication protocol. The peer-to-peer request messages are then sent to at least one processor in the fixed network communication network.

With a method for processing a request message sent from a mobile radio terminal of a mobile radio communication network to a message filter processor, a request message, in which one or more electronic peer-to-peer files is/are requested, is detected by the message filter processor. The format of the request message is essentially arbitrary, the request message being coded according to the mobile radio communication protocol and having a packet header with the information required for the forwarding decision.

The request message is used to create a peer-to-peer request message, the peer-to-peer request message being set up according to the peer-to-peer communication protocol to be used in each instance or in other words coded. The peer-to-peer request message is sent to at least one processor in the fixed network communication network, the requested electronic peer-to-peer files being specified according to the peer-to-peer communication protocol used in the peer-to-peer request message. This means that the mobile radio terminals “pre-reserve” by means of the request message in any data format, only one packet header being provided with specific information allowing forwarding and this being transmitted to the device. If the request message and then the peer-to-peer request message contain a destination address, specifying the address to which the requested electronic peer-to-peer files should be transmitted, for example an IP address of a destination processor, the invention can be considered to be the “pre-reserving” of the electronic peer-to-peer files by means of a mobile radio terminal. This makes it universally possible to control any peer-to-peer services remotely from a mobile radio terminal and thereby opens up the possibility of controlling peer-to-peer exchanges remotely in a mobile radio communication network.

The message filter processor is located in the mobile radio communication network and is managed and operated by the mobile radio communication network operator. The message filter in the mobile radio communication network is preferably arranged in the core network of the mobile radio communication network for example, when using a third generation mobile radio network.

The message filter processor can be addressed by an SGSN processor (Serving GPRS Support Node processor) or a GGSN processor (Gateway GPRS Support Node processor) or in the Radio Network Controller (RNC), when using a third generation mobile radio communication protocol, for example according to the GPRS or UMTS.

According to an advantageous embodiment the packet header has at least a first data area with a predefined data format and at least a second data area with a non-predefined data format, the data for identification being stored in a data area with a non-predefined data format. In one embodiment of the invention the data packet is an IPv6 type data packet. With this type of data packet, the second data area is referred to as a flow label, which is 20 bits in length and is currently used to mark quality of service. This flow label is a non-standardized field of the packet header and can be provided with information, which identifies a peer-to-peer service. The second data area can thereby be used wholly for the information to be coded. It is also possible just to provide sub-areas from the second data area with information and to carry out verifications at a network element in the mobile radio communication network.

The data packet sent from the mobile radio terminal is identified as generic peer-to-peer data traffic by the packet header such that it is possible for a network element, the SGSN, the RNC or the GGSN, to filter this data packet out efficiently from the remainder of the data stream and reroute it to the appropriate processor in the fixed network communication network. By using the second data area, it is possible to carry out sub-addressing, which is based neither on IP addresses nor on DNS names or TCP/UDP port numbers. To this end the second data area is used either wholly or partially to identify a specific peer-to-peer application, e.g. Gnutella, KaZaA, ICQ, etc. This assignment can either be unique to one mobile radio network operator or should be standardized universally.

If the second data area is used partially to identify a specific peer-to-peer service, the remainder of the second data area can be used for the transmission of metadata of interest in respect of the mobile use of peer-to-peer services. This includes for example the type of mobile radio terminal sending a peer-to-peer request or response. It can include the information whether a purely mobile radio terminal is involved or a portable computer. The metadata can contain information about the locally available storage space on the terminal. Metadata can also contain information about whether the peer-to-peer search algorithm data should be routed directly to the processor in the fixed network or not. The specific, current cell ID of the mobile radio communication network, which the mobile radio terminal itself can detect, could also be transmitted. This ID can be used for a location-related analysis. For example users of a peer-to-peer data exchange service within the same mobile radio cell can also exchange the data directly. This could be done for example using Bluetooth or IrDA, etc.

According to a further embodiment of the invention the fixed network communication network is based on Internet protocols, i.e. in particular on the Internet Protocol (IP) and the Transport Control Protocol (TCP).

According to a further embodiment the request message is detected in the mobile radio communication network.

In a further embodiment a destination address, to which the requested peer-to-peer files are to be sent, is detected from the request message of the mobile radio terminal and further processed.

The destination address is expediently integrated in the data of the second data area of the data packet. The second data area can also contain metadata.

In a further embodiment the destination address is assigned to a peer-to-peer application and stored in an assignment table in a message filter processor, in which the request message is detected. This procedure makes it possible to store the destination address stored as metadata outside the second data area of the data packet, as a result of which this storage space can be used for other types of metadata, as described above.

The message filter processor can thereby only detect and filter out the request message and forward it to another, preferably standalone processor, which interprets the request message and formulates or codes a corresponding peer-to-peer request message.

It is also possible to detect from the request message of the mobile radio terminal a destination address contained therein, specifying the address to which the requested peer-to-peer files are to be sent and to further process it. The destination address is for example an IP address of a processor on the Internet. It is therefore possible to reroute the requested data to the respective destination entity, i.e. to the destination processor specified by means of the destination address.

If the respective peer-to-peer service does not offers the direct option of rerouting the requested peer-to-peer files, a peer-to-peer proxy processor provided in the mobile radio communication network of the mobile radio communication network operator, in particular its IP address, can be input as the destination address for the data. The electronic peer-to-peer files can be buffered in the peer-to-peer proxy processor and downloaded by the mobile radio device at any time in the future.

On receipt of the required peer-to-peer files, the peer-to-peer proxy processor can inform the mobile radio terminal of receipt of such, for example by means of an electronic message, e.g. an SMS message.

The peer-to-peer proxy processor can forward the electronic peer-to-peer files transmitted to it to the destination address specified in the original request message, preferably as soon as the mobile radio terminal has re-established a previously uninterrupted communication connection with the peer-to-peer proxy processor. This simply means that the user of the mobile radio terminal is back “online”.

According to a further embodiment of the invention, there is provision for verifying, when reading and analyzing the second data area of the data packet, in particular the information identifying the peer-to-peer service, whether the requests for the peer-to-peer files are permitted according to a predefined permissibility criterion and the request is rejected if it is not permitted. Verification preferably takes place using the destination address.

There is also provision for the request message to undergo an authorization verification and the request message is only processed further if the request message satisfies predefined authorization criteria. This simply means that it is verified whether the user sending the request message is authorized to send a request message and to request the specified files.

There is also provision for the request message to undergo an authentication verification and the request message is only processed further if the request message satisfies predefined authentication criteria. The mobile radio terminal sending the request message is hereby authenticated and the request message is only processed further and used to create a peer-to-peer request message, if the authentication is successful.

With the method according to the invention request messages, with which data with an illegal content is requested, can be detected, blocked and in some instances reported to further entities in a simple manner.

If the device is managed by a mobile radio network operator, said operator can vouch for the respective user sending the mobile radio request message to the entities providing the electronic peer-to-peer files, as the user is known to the operator. This significantly simplifies electronic commerce.

The costs of buffering and possibly rerouting the electronic peer-to-peer files via the peer-to-peer proxy processor to the mobile radio terminal or user requesting the files can also be accounted for.

This results in a service being set up on the part of a mobile radio communication network operator of a mobile radio communication network, which receives requests to search for electronic peer-to-peer files of a specific name or type on the part of the mobile radio communication network. The request messages are issued using an IPv6 data packet. Additional parameters, such as for example the details of a destination processor, to which the electronic data is to be sent, can also be specified in the flow label of the data packet, along with the required peer-to-peer service. The request messages are converted according to the peer-to-peer communication protocol to be used in each instance to the format to be used, then coded and converted to a corresponding message complying with the peer-to-peer service used.

In the communication system according to the invention the message filter processor is set up to detect a request message, which is present in the form of a data packet, having a packet header and user data, in which one or a plurality of electronic peer-to-peer files is/are requested, detection of the request message involving reading data in the packet header of the request message, the data being used to identify a specific peer-to-peer application, to use the request message to create a peer-to-peer request message according to a predefined peer-to-peer communication protocol and to send the peer-to-peer request message to at least one processor in a fixed network communication network.

The same advantages are associated with the communication system according to the invention as have been described in relation to the method.

The invention and its advantages are described in more detail with reference to the Figures below, in which:

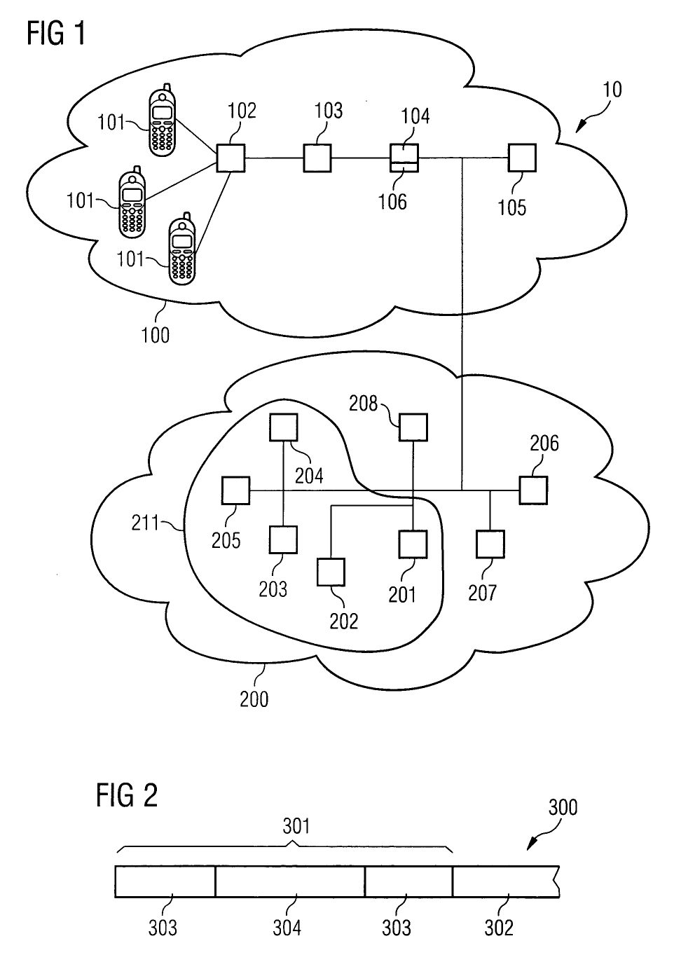

FIG. 1 shows a communication system with a fixed network communication network and a mobile radio communication network to implement the method according to the invention, and

FIG. 2 shows the schematic structure of a data packet with a packet header according to IPv6.

FIG. 1 shows a communication system 10 with a mobile radio communication network 100 and a fixed network communication network 200.

A plurality of processors 201, . . . , 208 is provided in the fixed network communication network 200, which are linked to each other. The fixed network communication network 200 is based on Internet protocols, i.e. the das Internet Protocol (IP) and the Transport Control Protocol (TCP) are used for communication. Peer-to-peer services are installed in a freely predefinable manner in the processors 201, . . . 205. The processors 201, 202, 203 are also set up for communication according to a respective peer-to-peer communication protocol, so that they can provide and use peer-to-peer services. For example file-sharing services and services for providing files, e.g. multimedia files, are provided in these processors 201, 202, 203. The processors 201, 202, 203 are also characterized in that multimedia files supplied by other peer-to-peer processors are stored there. In principle any peer-to-peer services and peer-to-peer communication protocols can be used.

The processors 202, 203 can represent peer-to-peer superpeer processors, which have superpeer functionality for some or all of the peer-to-peer services available in the network. They thereby serve as index servers for the respective peer-to-peer service.

The processors 201, 204, 205 and the superpeer processors 202, 203 form a so-called generic peer-to-peer network 211. This is a virtual network of processors, which can communicate with each other according to the respective peer-to-peer service or the respective peer-to-peer communication protocol.

A plurality of mobile radio terminals 101 is provided in the mobile radio communication network 100, which are set up to provide or use peer-to-peer services. The mobile radio terminals 101 are linked via a radio connection to a base station 102 and by means of said base station to an SGSN processor 103 and also to a GGSN processor 104, so that the mobile radio terminals 101 can exchange messages according to the respectively used mobile radio protocol with the GGSN processor 104. In the present exemplary embodiment the mobile radio communication network 100 is set up according to the UMTS standard.

The GGSN processor 104 primarily serves as a mobile radio network-fixed network interface processor. It is set up to map a data stream coming in from the fixed network communication network 200 onto the communication protocol used in the mobile radio communication network 100. It is also set up to map a data stream coming in from the mobile radio communication network 100 onto the communication protocol or its data formats used in the fixed network communication network 200.

A message filter 106 is provided in the GGSN processor 104, which is in the form of a computer program and can detect messages in the data stream coming in to the GGSN processor 104 requesting electronic peer-to-peer files or more generally peer-to-peer services.

This is achieved in the manner that the request message sent from a mobile radio terminal 101 to the GGSN processor 104 is decoded. According to this exemplary embodiment the request message is present in the form of a data packet according to the IPv6 standard. A data packet according to this standard has a packet header 301 and user data 302. This is shown as an example in FIG. 2. The packet header 301 is divided into a first data area 303 with a predefined format and a second data area with a non-predefined data format. The start or end of the packet header is defined in the first data area 303. The second data area 304, also referred to as a flow label, is 20 bits in length and is not defined in respect of the data structure of the data format. According to the concept of this invention, this data area is also used to store information identifying a peer-to-peer service. The entire second data area can be used to identify the peer-to-peer service. It can however also just be partially used, so that the remaining area can be used for metadata, which is of interest in respect of the mobile use of peer-to-peer services.

The following information can be contained in the second data area of the IPv6 data packet:
details of the required peer-to-peer service to be used, i.e. details of the peer-to-peer protocol format to be used and the peer-to-peer communication protocol to be used;
a destination address, by means of which the address of the processor, to which the requested electronic peer-to-peer files are to be sent, is specified;
in the event that the required peer-to-peer service does not offer the direct option of rerouting the requested electronic peer-to-peer files, the IP address of a peer-to-peer proxy processor 105 can be specified as the destination address, said proxy processor also being located in the mobile radio communication network 100 and being managed and operated by the operator of the mobile radio communication network. This buffers the peer-to-peer files supplied by the respective peer-to-peer processor until they are retrieved by the mobile radio terminal or forwards these to the mobile radio terminal sending the request message;
details of the mobile radio terminal sending the request message; additional information, serving for example for purposes of authorization, authentication or the provision of accounting services.

With the exception of details of the required peer-to-peer service to be used, the above-mentioned data can also be contained in a separate file, for example one stored in the GGSN processor. Specifying the peer-to-peer service to be used in the second data area of the IPv6 data packet means that the corresponding information can then be read from the list by the GGSN processor.

The method according to the invention allows identification that is specific to the peer-to-peer service and action relating to a specific service, e.g. blocking a requested service. By marking the IP data packet in its packet header, it is possible for network elements, particularly in the mobile radio communication network, to make decisions about packet forwarding, which are not based on analysis by higher protocol layers. This means that certain data streams can be specifically forwarded to other network elements or application servers.

A further advantage lies in the fact that it is no longer necessary to preconfigure specific IP addresses or DNS names in the application software on the mobile terminal. Using the second data area of the packet header allows unique addressing between the superpeer processor and mobile radio terminal, without a specific IP address being required for each mobile radio terminal. The second data area could for example also be replaced by parts of the IMSI (International Mobile Subscriber Identity).

The advantage for the end user is the efficient processing of peer-to-peer requests by specialized network elements, like the message filter in the GGSN processor 104. It is also possible for the operator to control the data flows in the peer-to-peer network and bill for them separately.

A further advantage is the efficient management of the bandwidth of the data to be transmitted via the [lacuna]. Examples of this are error rate, error protection or packet delivery prioritization.

To return to FIG. 1, the message filter 106 verifies whether the user of the mobile radio terminals 101 has adequate authorization to make the detected request. The authorization verification does not necessarily have to be carried out by the message filter 104 but can be provided by any suitable entity.

When both the authentication and also the authorization have been successfully completed by the GGSN processor 104, the GGSN processor 104, or alternatively a processor provided specifically for the authentication, uses the information in the request message to create a peer-to-peer request message, which is transmitted to the fixed network processor in the peer-to-peer network 211. If one of the processors 201, . . . , 205 can provide the requested service in the peer-to-peer network 211, it supplies it to the GGSN processor 104 according to the peer-to-peer request message and transmits a message stating that the requested electronic peer-to-peer file can be downloaded to the processor specified in the destination address. The peer-to-peer proxy processor 105 stores the result message and downloads the requested electronic peer-to-peer file from the corresponding peer-to-peer server and buffers this and waits for a further request from the mobile radio terminal 101, by means of which said terminal downloads the electronic file buffered in the peer-to-peer proxy processor 105.

Alternatively the received electronic peer-to-peer file can be transmitted automatically to the mobile radio terminal 101 sending the request message. It is also possible to download the requested electronic peer-to-peer file directly from the corresponding peer-to-peer server using the mobile radio terminal 101.

These alternative embodiments can be deployed individually for each mobile radio terminal 101.

1. Method for processing a request message sent from a mobile radio terminal (101) of a mobile radio communication network (100) to a message filter processor (102,103,104), in which
a request message, in which one or more electronic peer-to-peer files is/are requested, is detected by the message filter processor (102,103,104),
the request message is used to create a peer-to-peer request message according to a predefined peer-to-peer communication protocol,
the peer-to-peer request message is sent to at least one processor (201 . . . 207) in a fixed network communication network (200), and
the request message is present in the form of a data packet (300), having a packet header (301) and user data (302), detection of the request message including reading data in the packet header (301) of the request message, the data being used to identify a specific peer-to-peer application.

2. Method according to claim 1,
characterized in that
the packet header (301) has at least a first data area (303) with a predefined data format and at least a second data area (304) with a non-predefined data format and the identification data is stored in a data area with a non-predefined data format.

3. Method according to claim 1,
characterized in that
the data packet is a type IPv6 data packet.

4. Method according to claim 2,
characterized in that
the second data area (304) is the flow label.

5. Method according to claim 1,
characterized in that
communication in the fixed network communication network (200) is based on Internet protocols.

6. Method according to claim 1,
characterized in that
detection of the request message takes place in the mobile radio communication network.

7. Method according to claim 1,
characterized in that
a destination address, to which the requested peer-to-peer files are to be sent, is detected from the request message of the mobile radio terminal (101) and further processed.

8. Method according to claim 7,
characterized in that
the destination address is integrated in the data of the second data area (304) of the data packet.

9. Method according to claim 7,
characterized in that
the destination address is assigned to a peer-to-peer application and stored in an assignment table in a message filter processor (102,103,104), in which the request message is detected.

10. Method according to claim 7,
characterized in that
when reading and analyzing the second data area (303) of the data packet (300), it is verified whether the request for the peer-to-peer files is permitted in respect of a predefined permissibility criterion and the request is rejected if it is not permitted.

11. Method according to claim 10,
characterized in that
verification takes place using the destination address.

12. Method according to claim 7,
characterized in that
the request message undergoes an authorization verification and the request message is only processed further if the request message satisfies predefinable authorization criteria.

13. Method according to claim 7,
characterized in that
the request message undergoes an authentication verification and the request message is only processed further if the request message satisfies predefinable authentication criteria.

14. Computer program product with codes to implement the method according to claim 7.

15. Communication system for processing a request message sent from a mobile radio terminal (101) of a mobile radio communication network (100) to a message filter processor (102,103,104), in which the message filter processor (102,103,104) is set up to,
detect a request message, which is present in the form of a data packet (300), having a packet header (301) and user data (302), in which one or more electronic peer-to-peer files is/are requested, detection of the request message including reading data in the packet header (301) of the request message and the data being used to identify a specific peer-to-peer application,
use the request message to create a peer-to-peer request message according to a predefined peer-to-peer communication protocol, and
send the peer-to-peer request message to at least one processor (201 . . . 207) in a fixed network communication network (200).
